(19) United States
(12) Patent Application Publication
(10) Pub. No.: US 2010/0023371 A1
(43) Pub. Date: Jan. 28, 2010

(54) Marketplace in Ideas

(76) Inventors: Nikolai F. Hartz, Munich (DE); Gunter Wachtershuser, Munich (DE)

Correspondence Address: NEIFELD IP LAW, PC, 4813-B EISENHOWER AVENUE, ALEXANDRIA, VA, 22304, US

(21) Appl. No.: 11/721,316

(22) PCT Filed: Dec. 2, 2005
(86) PCT No.: PCT/EP05/12920

§ 371 Date: Jun. 8, 2007

Related U.S. Application Data
(60) Provisional application No. 60/634,595, filed on Dec. 10, 2004.

(51) Int. Cl. G06Q 30/00; G06Q 50/00; G06Q 10/00

(52) U.S. Cl. 705/10; 705/26

(57) ABSTRACT

A system for implementing a marketplace in ideas, which comprises
a means (1) for conducting an online auction of patents and patent applications;
a means (2) for providing a survivability rating of a patent or patent application subject to the online auction, which is based on a standardized method evaluating the probability by which the value of a patent or patent application might become zero in the future,
whereby the means (1) and the means (2) are communicating over a network by sending requests for a survivability rating for a specific patent or patent application from means (1) to means (2).

### FIELD OF THE INVENTION

The present invention relates to a marketplace in ideas. In particular, the present invention relates to a system for implementing a marketplace in ideas, and a process for practicing a marketplace in ideas. More specifically, the present invention relates to a method, system, and computer program product for an intellectual property auction style transaction among competitors and further members of the public, in particular with regard to intellectual property of patent proprietors and patent applicants which are in bankruptcy proceedings. The auction style transaction may be initiated by a proprietor of the intellectual property, or alternatively by a potential buyer of the intellectual property. The transaction may involve a standardized patent asset which may be used as a financial instrument.

### BACKGROUND OF THE INVENTION

European patents are granted by the European patent office (EPO) based on European patent applications disclosing technical subject-matter. European patents and European patent applications are considered as intellectual property assets of the applicant or patent proprietor. Patent applicants and patent proprietors who have filed for bankruptcy loose control over the intellectual property assets. The control is transferred to an administrator of the bankrupt estate whose primary interest is in selling assets for meeting existing financial obligations. Since the market for patent assets lacks transparency, the administrator of the bankrupt estate usually has to rely on a limited circle of potential buyers having insider knowledge of the patent assets and bankrupt company, which go beyond the knowledge of the administrator's knowledge and capacity.

Patent procedures before the EPO or the maintenance of patents in the national patent offices require a continuous financial commitment on the part of the patent applicant or patent proprietor. If a patent applicant or patent proprietor does not meet the necessary financial obligations, the patent application or patent disappears as an intellectual property asset after a certain period of time, and the previous financial investment turns essentially into a loss. In case of a bankruptcy of a patent applicant or patent proprietor, patent assets are frequently abandoned since a buyer for the intellectual property cannot be found. Even in case of a sale of a patent from a bankrupt entity to a third party, the price paid for the patent asset is often far below the value of the patent asset. The low price is often the result of insider knowledge of the buyer, frequently a former employee, and the constraints under which the deal is made in bankruptcy proceedings. Therefore, there is a need for a patent asset value protection system.

European patents and European patent applications are transferable from the respective applicant or proprietor to a third party. The transfer requires (a) a suitable third party and (b) a formal act on the part of the applicant or proprietor and the third party. Due to the specialized and unique nature of a patent or patent application and the confidential nature of industrial projects, the proprietor or applicant and a potential buyer are faced with the problem of even starting a negotiation. Since patents and patent applications require at least annuity fee payments for maintenance, which put the proprietor of a patent or patent application under a time constraint, many patents and patent applications are abandoned given the problems of identifying a suitable third party and the difficulties and costs in negotiating a transfer.

Sometimes, problematic freedom to operate situations exist for third parties wherein the technology of a member of the public is blocked by a patent asset which might eventually be abandoned. The member of the public may usually choose between negotiating a license, changing the technology in order to circumvent the blocking patent or trying to eliminate the monopoly based on appropriate proceedings. Any of the alternative involves a substantial investment of time, effort and money whereby the success of any of the alternatives is by no means certain. Moreover, in case the patent asset is finally abandoned, for example due to a bankruptcy of the patent proprietor, freedom to operate is established, but the potential value of the patent asset is also lost for the third party. Therefore, there is a need for an efficient patent asset transfer system.

The lapse of a patent or patent application destroys its value as an asset. Moreover, the lapse of a patent or patent application destroys protection necessary for acquiring capital such as venture capital for the development of an actual product, independent from the proprietor. The lapse of a patent or patent application also destroys its unknown potential value for third parties. Since published patents and patent applications constitute prior art for later filings, abandoned disclosures may even destroy the interest of third parties in the subject-matter for lack of availability of protection in this field without making a further invention. In case of a bankruptcy of a patent proprietor or patent applicant, the problems are aggravated since the intellectual property is rarely appreciated as a valuable asset and often abandoned. Accordingly, valuable assets are destroyed contrary to the purpose of the bankruptcy proceedings. Therefore, there is a need for a patent asset conservation system.

In the light of the above situation, patent or patent application transfers are usually part of complex transactions between related entities, which involve a number of assets often not limited to intellectual property assets. In particular in bankruptcy proceedings, intellectual property is sold, if at all, as part of a larger transaction.

Therefore, the current practice may be characterized as a proprietor centered model, wherein patents and patent applications are considered as linked to a business activity of the proprietor. The transfer of single patents or patent applications between unrelated entities does not take place. Therefore, a market in ideas wherein patents and patent applications are transferred according to an asset centered model currently does not exist.

Internet sites offering intellectual property and technology are known. Examples are yet2.com, PATEX.com, PatentAuction.com, p-Ix.com and eBay.

### SUMMARY OF THE INVENTION

It is the problem of the present invention to provide a marketplace in ideas. In particular, it is the problem of providing a system of elements for implementing a transparent marketplace in ideas which allows to buy or sell patent assets within a short period of time preferably without substantial financial commitment on the part of the seller and preferably anonymously and without substantial transaction costs on the part of the buyer, in particular during bankruptcy proceedings of the patent proprietor or applicant, within a large and informed group of potential buyers.

Moreover, it is a problem of the invention to provide a process for practicing a marketplace in ideas, in particular by joining potential investors and patent proprietors or applicants during bankruptcy proceedings.

The problems associated with intellectual property transactions during bankruptcy proceedings are similar to the problems encountered during the restructuring of a business or the abandonment of a portion of an existing intellectual property portfolio: Patent assets which are to be abandoned potentially represent a value for a third party. However, a transaction usually does not take place wherein the patent asset is transferred since either the patent proprietor does not invest any further effort into the patent asset or the third party does not have a standardized mechanism for efficiently and anonymously checking the availability of a specific patent asset without incurring high costs.

These and other problems are solved according to the claims. The present invention suggests a centralized marketplace of survivability rated intellectual property and related rights in the form of an online auction of patents and patent applications, notably standardized patent assets, preferably represented by a dedicated entity.

According to a first aspect, the present invention provides a system for implementing a marketplace in ideas, which comprises:

a means for conducting an online auction of patents and patent applications;
a means for providing a survivability rating of a patent or patent application subject to the online auction, which is based on a standardized assessment evaluating the probability by which the value of a patent or patent application might become zero in the future,
whereby the means for conducting an online auction of patents and patent applications and the means for providing a survivability rating of a patent or patent application subject to the online auction are communicating by sending requests for a survivability rating for a specific patent or patent application from the means for conducting an online auction to the means for providing a survivability rating, and by sending a survivability rating for a specific patent or patent application from the means for providing a survivability rating to the means for conducting an online auction.

Preferably, the system further comprises a means for representing a patent or patent application subject to the auction before the patent offices, in particular the European or national patent offices.

The patent or patent applications are preferably standardized patent assets. The standardized patent assets are preferably defined by a reference to a unique official file number, a territory covered by the patent asset, a survivability rating and optionally a reference to a classification of the technical field to which the claimed subject matter relates. The unique official file number identifies a specific disclosure of an invention pending in a reference patent office. The reference patent office may be the selected based on the quality of the procedure available in this office. Most preferably, the reference patent office is the patent office providing the highest available quality in terms of search and examination as a basis for the survivability rating. The choice of the official file number of the patent office providing the highest available quality provides a solid basis for a rating. Most preferably, the publication number is selected in order to have a publicly available file as a basis for a rating. The territory identifies the countries actually or potentially covered by a patent monopoly and thereby the direct equivalents of the same patent family in the respective countries. The survivability rating identifies the intrinsic risk associated with the patent asset. The patent or patent applications may also be organized in a portfolio of patent assets each defined by a reference to a unique official file number, a territory covered by the patent asset, a survivability rating and optionally a reference to a classification of the technical field to which the claimed subject matter relates. The patent assets of a portfolio are preferably held by a single entity entitled to sell the patent assets. Accordingly, the portfolio represents a combination of patent families. The transformation of a patent asset to a standardized patent asset and the combination of patent assets to a portfolio may facilitate the use of the asset as a financial instrument.

The online auction style transaction may in a preferred embodiment be initiated by a potential buyer. Specifically, in this embodiment, the potential buyer defines a standardized patent asset and anonymously requests the patent proprietor or patent applicant through the means for conducting an online auction of patents and patent applications that the standardized patent asset be included into the marketplace while at the same time communicating a binding bid.

According to a second aspect, the present invention provides a method for practicing a marketplace in ideas, which comprises the following steps
providing a means for conducting an online auction of patents and patent applications;
providing a means for providing a survivability rating of a patent or patent application subject to the online auction, which is based on a standardized assessment evaluating the probability by which the value of a patent or patent application might become zero in the future,
receiving a request to include a patent or a patent application into the online auction of patents and patent applications;
sending a request for a survivability rating of the patent or patent application subject to the online auction from the means for conducting an online auction of patents and patent applications to the means (2) for providing a survivability rating of a patents or patent application subject to the online auction;
sending a survivability rating of the patent or patent application subject to the online auction from the means (2) to the means (1) and displaying the rating in the listing of the patent or patent application subject to the online auction;
conducting an online auction of the survivability rated patent or patent application.

According to a preferred embodiment, the patent or patent applications are standardized patent assets.

According to a further preferred embodiment, the request to include a patent or a patent application, preferably as a standardized patent asset, into the online auction of patents and patent applications is received from a potential buyer.

According to a further embodiment of the method, two or more standardized patent assets may be combined to a portfolio containing standardized patent assets of the same patent applicant or patent proprietor.

According to a third aspect, in a first alternative, the present invention provides a means for conducting an online auction of patents and patent applications, which is a computer system comprising:
at least one computer;
at least one computer network connected to said computer;
means for receiving electronic offer information regarding an intellectual property asset from a prospective seller over said at least one computer network;
means for electronically forwarding offer information to a means for providing a survivability rating of a patent or patent application over said at least one computer network or another computer network;
means for receiving from the means for providing a survivability rating of a patent or patent application an electronic message indicating an objective survivability rating;
means for entering a record of such offer information and survivability rating into a database electronically accessible to a plurality of potential bidders over said at least one computer network or another computer network;
means for maintaining said record of such offer in said database accessible to said plurality of potential bidders for a predetermined period of time;
means for allowing said plurality of potential bidders to submit bids over said at least one computer network on such survivability rated offer of an intellectual property asset;
means for allowing the seller to access information regarding said bids excluding the identity of the bidders, from said plurality of bidders over said at least one computer network; and
means for determining a winning bid, and preferably deleting any other bid information from the computer system memory.

According to a third aspect, in a second alternative, the present invention provides a means for conducting an online auction of patents and patent applications, which is a computer system comprising:
at least one computer;
at least one computer network connected to said computer;
means for receiving over said at least one computer network from a potential buyer electronic request information including a definition of a patent asset and a binding bid, for including an intellectual property asset into an online auction;
means for forwarding request information to the owner of the intellectual property asset without disclosing the identity of the potential buyer, preferably over said at least one computer network or another computer network, together with a request for communicating a decision on the request;
means for electronically forwarding request information to a means for providing a survivability rating of a patent or patent application over said at least one computer network or another computer network in case the request was granted by the owner of the intellectual property asset;
means for receiving from the means for providing a survivability rating of a patent or patent application an electronic message indicating an objective survivability rating;
means for entering a record of such request information and survivability rating into a database electronically accessible to a plurality of potential bidders over said at least one computer network or another computer network;
means for maintaining said record of such request in said database accessible to said plurality of potential bidders for a predetermined period of time;
means for allowing said plurality of potential bidders to submit bids over said at least one computer network on such survivability rated offer of an intellectual property asset;
means for allowing the seller to access information regarding said bids excluding the identity of the bidders, from said plurality of bidders over said at least one computer network; and
means for determining a winning bid, and preferably deleting any other bid information from the computer system memory.

According to a fourth aspect, the present invention provides a computer readable medium containing program instructions for execution on a computer system, which when executed by the computer system, cause the computer system to perform method steps for auctioning an intellectual property asset, said method comprising the steps of:
receiving a request to include a patent or a patent application into the online auction of patents and patent applications;
sending a request for a survivability rating of the patent or patent application subject to the online auction to a means for providing a survivability rating of a patents or patent application subject to the online auction;
receiving a survivability rating of the patent or patent application subject to the online auction from the means to the means for conducting an online auction of patents and patent applications;
conducting an online auction of the survivability rated patent or patent application.

The present invention is based on the assumption that patents and applications may be considered completely decoupled from the current proprietors or applicants and are potentially valuable transferable intellectual property assets as such. The assumption allows to use patents or patent applications as financial instruments rather than defensive monopolies of a specific original inventor regarding a specific technology.

The present invention is furthermore based on the assumption that the actual value of patents and patent applications cannot properly be determined by the patent proprietor or patent applicant, since the value of a patent or patent application is ultimately dependent on the interest of a third party acquiring the patent or patent application. Only in conventional corporate transactions involving the transfer of a large number of assets between related entities, it is usually possible to negotiate a value satisfactory for the parties. However, such negotiation depends on an agreement between the parties on the intrinsic value of a patent asset (survivability) and an agreement between the same parties on an extrinsic value based on the future development of a product on a market in the context of the specific overall corporate transaction. The present invention teaches a decoupling of the determination of intrinsic value by an independent rating and the determination of the extrinsic value by an auction involving the entire marketplace.

The present invention furthermore is based on the assumption that the conventional coupling of intellectual property rights to the business entities of the proprietors is the consequence of the difficulties of the patent proprietor or applicant to find a third party suitable for a transfer of a patent or patent application to be abandoned, and in the difficulties and costs for a patent proprietor or applicant and the third party to determine a suitable value of the patent or application. Presently, the transfer of ideas is characterized by a mechanism wherein the party which would even accept a loss for previous investments by abandoning the patent or application, has to take the initiative in finding a suitable third party, and by taking a weak position in the negotiations on the value when making an offer to a potential third party. Moreover, in view of the uncertain outcome of the negotiations, a potentially interested third party might not be ready to disclose its interest in the subject matter of the patent or application. Moreover, the evaluation of an offer by the patent proprietor or applicant requires a considerable effort on the part of a third party in evaluating the nature of the subject intellectual property. Moreover, a decision on the part of the third party generates a responsibility of the decision maker, which might not be acceptable in view of the risk and size of the investment.

Accordingly, the present inventions provides a system which reverses this mechanism in that the patent proprietor or applicant is provided with a means for conducting an online auction style transaction involving patents and patent applications. The present invention also provides a system wherein a third party may approach the registered proprietor (owner) of a patent asset anonymously with a request to include a patent asset into the online marketplace together with a binding bid. The registered proprietor may either grant the request, refuse the request or change the request whereby in the latter case, the third party is no longer bound to the bid submitted with the request.

Finally, the present invention is based on the assumption that patent portfolios usually only contain a very small number of core business related patents and patent applications whereas a large portion of the patent portfolio might be available for a transfer once a reasonable and binding offer is presented and the patent proprietor or applicant may hope to further increase the final sales price by using an active market place with competing bidders.

The seller initiated auction style transaction starts with the patent proprietor or patent applicant registering with the means for conducting an online auction of patents or patent applications, identifying an intellectual property asset, and requesting that the intellectual property asset be included in the auction. Given the omnipresent danger of online crime and the easy availability of patent related data from publicly available databases, appropriate steps are necessary to discourage an abuse of the marketplace. In one embodiment, the registration of a new user must be confirmed based on a valid email address whereby optionally certain Email addresses, e.g. which may be obtained free of charge, are excluded. In a further embodiment, the identity of the new user is checked and confirmed by a trustee indicated by the new user. The trustee may preferably be a professional in the field of intellectual property registered with a patent office and bound by professional rules of conduct. The trustee may be a patent attorney, patent agent or a qualified attorney a law or other individual or entity bound by professional codes of conduct and registered in a public database. In a further embodiment, the seller may be requested to make specific warranties on his entitlement and the intellectual property asset. Moreover, a bidder may be requested to provide further guarantees, e.g. from a banking institution that he will be meeting his financial obligations in case of a winning bid.

Preferably, the seller defines a standardized patent asset by entering a unique official number of the patent asset, e.g. the publication number of the equivalent in a specific patent office. The further particulars may then be retrieved from the official file of the patent office by the means for conducting an online auction for confirmation of the seller. Subsequently, the seller is requested to define the territory covered by the standardized patent asset. The territory may be limited to the territory or a portion thereof of the asset in the specific patent office. It may include this territory and further territories where other equivalents are active. It even may exclude the territory of the equivalent of the specific patent office, but include other territories. Finally, the seller may specify further information regarding the patent asset for the information of the public including publications of the technology, details on his entitlement, the question of transfer of rights from the inventors, the presence of certain licenses including a reservation for maintaining a license for himself, existing products on the market, availability of further data and know-how, and reasons for the sale. Finally, the seller may specify further auction-related particulars such as the minimum bid and the duration of the auction-style transaction.

In case the patent proprietor or applicant is in bankruptcy proceedings, an authorized administrator of the bankrupt estate of the patent proprietor or applicant may register for the patent applicant or proprietor, identify an intellectual property asset and request that the intellectual property asset be included in the auction.

The intellectual property asset may include a patent, a patent application, or a patent claim. The intellectual property asset may also be a portfolio including two or more patents, patent applications, or patent claims. The patent portfolios may include a single patent family containing multiple direct equivalents linked by a common priority. The patent portfolio may also include multiple patent families optionally containing multiple direct equivalents linked by a common priority. The use of patent portfolios which are offered as a package may be essential in cases where the value of the technology is destroyed in case a number of competitors control subsets of the portfolio and are able to use the corresponding monopolies against the competitors. Preferably, the portfolio contains two or more standardized patent assets.

The means for conducting an online auction of patents or patent applications verifies the data provided by the patent proprietor or patent applicant, in particular the entitlement of the requesting party to offer, sell and assign the patent asset.

Subsequently, the means for conducting an online auction of patents or patent applications notifies the public on behalf of the patent proprietor or applicant that a specific intellectual property asset is available for a transfer in the online auction for patent and patent applications together with an objective survivability rating. The notification may preferably occur in a standardized format. The standardized format defines a standard patent asset based on a set of abstract particulars. In one embodiment, the standard patent asset is defined by an identifier such as an official file number which may correspond to the publication number of a patent application in a specific patent office such as the European Patent Office thereby characterizing the invention disclosure. The official file number may be combined in the definition of a standard patent asset with the territory covered by the offered patent asset. It is not necessary that the territory covered by the offered patent asset includes the territory for which the specific patent office acts from which the official file number is adopted for defining the standard patent asset. Rather, the official file number serves as a unique identifier for an invention disclosure which may be active in many different patent offices under different other official numbers. Accordingly, it is possible to distinguish a patent asset of an invention disclosure pending in the European Patent Office under the publication number EP 1 234 567 covering the territory of EP and US from a different patent asset of the same invention disclosure pending in the European Patent Office under the publication number EP 1 234 567 covering the territory of JP. The standardized format may further include the standardized survivability rating. Optionally, the standardized format may also include particulars regarding the class of inventions to which the claims are directed, e.g. by referring to an IPC class. The standardized format allows for a simplification of the management and exchange of patent assets by representing a complex patent asset structure by a reduced set of particulars, namely a unique number for an invention disclosure, a territory, an indication regarding the risk of default of the patent asset, and optionally an abstract indication regarding the technology.

The notification may occur because specific members of the public check the public listing of the means for conducting an online auction of patents and patent applications. The notification may also occur because of a communication of the means for conducting an online auction of patents and patent applications directed to specific members of the public. The communication may be triggered by a previous request from the specific members of the public to be notified if an intellectual property asset meeting specific criteria is entered into the online marketplace. Additionally, the patent proprietor or applicant or an authorized representative thereof may notify the public about further assets subject to the auction or licenses or options which are associated with the patent or patent application. The current proprietor or applicant may reserve a non-exclusive license or any other license type reservation for himself. Instead of a patent application, the patent applicant may submit a set of claims to be filed in a divisional application. Accordingly, if the auction was successful, a divisional application is filed, which is then transferred to the party successful in the auction. Finally, licenses may also be subject to the auction.

Moreover, the public is notified that bids are accepted within a certain term. The term may be a term determined by the proprietor or applicant. By default, the auction may end before the application or patent will lapse, be deemed withdrawn or be refused without any further action, whereby sufficient time for a transfer may be allowed. Accordingly, the patent proprietor or applicant does not need to take any further action apart from notifying the means for conducting an online auction of patents and patent applications and requesting that the specific intellectual property asset be included in the auction. The bidders may be invited to extend the bidding term by payment of the annuity fees. Accordingly, a bidder may decide to keep a potential intellectual property asset alive in order to have more time to consider a possible bid.

As a result of the auction, the intellectual property asset may not be transferred to a bidder for lack of a bid or lack of an acceptable bid. This alternative is identical for the patent proprietor or applicant with the abandonment of the patent or application by not taking any further action. On the other hand, if the patent asset is acquired in the patent auction by a bidder, then the patent proprietor or applicant will be in a position that a loss of previous investments may be avoided, or that even a profit is made with the transfer of a patent or application which would otherwise be abandoned. This possibility is particularly important for bankruptcy proceedings. Most importantly, the patent proprietor or applicant does not need to take any action beyond registering with and notifying the means for conducting an online auction of patents and patent applications and requesting that a specific patent asset be included in the auction, and if the auction was successful, transferring the patent or patent application.

The auction may follow different auction models. In one embodiment, the auction is anonymous on the part of the bidding third parties. Accordingly, the bidder may not risk to disclose his interest in a patent asset and be unsuccessful in the auction. On the other hand, a bidder may choose to disclose his identity. This embodiment might be combined with the possibility of the bidder to submit facts and evidence to the means for conducting an auction, which are able to invalidate the patent, thereby changing the survivability rating and the ultimate winning price. An anonymous allegation of public prior use will not have any effect. However, an allegation made by a credible bidder may be taken into account by the public.

In a further embodiment, the auction may allow the patent proprietor or applicant to indicate a reservation. A reservation is an unspecified information of the bidders that the patent or patent application will only be transferred if the winning bid is above a certain limit. The exact limit is not disclosed to the bidders thereby providing an incentive for the bidders to provide a reasonable bid.

In a further embodiment, a patent applicant or proprietor may include a patent asset into the online auction without specifying the end of the online auction. From the perspective of the public, the patent asset represents an unspecified indication that the patent asset is for sale. As soon as the first bid is received by the means for conducting an online auction, the applicant or proprietor of the patent asset is notified of the bid and required to set a term for terminating the online auction. Alternatively, a standard term may be applied by the means for conducting and online auction. The bid is placed anonymously so that patent applicants or proprietors cannot use a means for conducting an online auction for the purposes of determining potential competitors. If the patent applicant or proprietor declines to indicate a term for terminating the online auction, the patent asset is eliminated from the means of conducting an online auction. However, if the patent applicant or proprietor indicates a term for terminating the online auction, a regular auction will take place. Alternatively, that term for terminating the online auction may be a standard term. In a further alternative, that term may be determined by the means for conducting an online auction. Within the term for conducting the online auction, further third parties may take part in the bidding process. Accordingly, the patent applicant or proprietor is a position to increase the final sales price. The patent applicant or proprietor may also indicate a reservation in order to avoid the sale of the patent asset to an unrealistically low price. In a further embodiment, the auction may be initiated by a third party. Accordingly, a third party selects a patent asset owned by a different entity and suggests this patent asset for the patent auction together with a bid. The third party may choose to remain anonymous. The means for conducting an online auction notifies the patent applicant or proprietor of the bid of the third party for the specific patent asset. From the perspective of the patent applicant or proprietor, the notification represents an offer from an undisclosed bidder. Accordingly, the patent applicant or proprietor may answer the notification by declining the offer. Alternatively, the patent proprietor or applicant may chose to introduce the patent assets into the online patent auction whereby the patent asset will be listed together with a first bid which is binding for the third party. The patent proprietor or applicant may also choose to decline the original offer and to enter the patent asset into the auction based on different terms whereby the original bid of the third party becomes void. However, the third party may reconsider the offered asset and place a new bid. The term by which the online auction will terminate be determined, within certain limits, by the patent applicant or proprietor. Alternatively, a standard term set by the means for conducting an online auction may apply. In case the patent applicant or proprietor chooses to open and auction, the public will be informed about the pending patent transaction. If a competitor of the patent applicant or proprietor and the third party also has an interest in the patent asset, he may place a further bid. As a result, the patent applicant or proprietor well be a position to obtain a better price for his patent asset as if he would have negotiated with the third party directly. On the other hand, the third party does not need to disclose its identity prior to having acquired the patent asset. If the patent asset is only of interest for the third party, the third party may acquire the patent asset for a competitive price, provided that the patent applicant or proprietor has previously accepted the bid and introduced his patent asset into the online auction. Given that the patent applicant or proprietor would have never gotten in touch with an interested third party, even a low price would be a benefit if he had previously considered to sell his patent asset. If, however, a patent asset is of interest to more than a single third party, the price of the patent asset may be considerably higher. This possibility represents an incentive for the patent applicant or proprietor to open the patent auction in case of the notification from the means for conducting an online auction. Of course, it is possible for the patent applicant or proprietor to announce a reservation in order to avoid that his patent asset is being sold for an unrealistically low price. The fact, that the patent applicant or proprietor has indicated a reservation will be published by the means for conducting an online auction. Accordingly, the third parties able to reconsider it's bid and to place a new bid in order to increase the chances of acquiring the patent asset.

The means for conducting an online auction of patents and patent applications may preferably comprise a means for representing a patent or patent application subject to the auction, in particular before the European or national patent offices. Since the patent proprietor or applicant typically does not want to invest any further funds in the subject patent or application, and since the end of the auction may be close to the lapse of the patent or application, it will be necessary that the transfer be reliably managed. Accordingly, the means for representing a patent or patent application subject to the auction will take over representation as soon as the patent or patent application is included in the patent auction.

The system of the present invention further comprises a means for providing an independent survivability rating of a patents or patent application subject to the online auction, which is based on a standardized assessment evaluating the survivability of the patent or application as an intellectual property asset in the future. The assessment represents a current opinion on the likelihood that the patent or patent application will be limited or disappear as an intellectual property asset due to patentability issues of the claimed subject matter. The survivability assessment is based on current information available from public databases such as the published documents and the content of the official patent register and an online file inspection. The survivability assessment may be changed, suspended or withdrawn during the term of the online auction as a result of changes or events occurring in the procedures of the patents and patent applications.

The independent survivability rating of the patents and patent applications is indicated by the means for conducting an online auction of patents and patent applications in the context of the listing of the respective patent or application. The rating may use a system wherein a patent or patent application is assigned a number of stars depending on the likelihood that the patent or application will be limited or disappear as an intellectual property asset due to patentability issues of the claimed subject matter. Accordingly, a five star rating would correspond to an extremely strong likelihood for the patent or application to survive, whereas a one star rating would indicate a high vulnerability of the claimed subject matter. A five star rating could be given for a patent which has been granted by the EPO, challenged in opposition proceedings and survived the opposition appeal proceedings. A one star rating could be given for an application which is confronted in examination proceedings with a number of references considered highly relevant for all claims. The cases wherein no star is given may be reserved for patents or patent applications which are revoked or refused, but which are currently pending in appeal. Accordingly, the following objective survivability rating system may be used:

5 stars indicate an extremely strong likelihood for the patent or application to survive
4 stars indicate a strong likelihood for the patent or application to survive
3 stars indicate adequate likelihood for the patent or application to survive
2 stars indicate uncertainties regarding likelihood for the patent or application to survive
1 star indicates a currently vulnerable patent or application
0 stars indicate patents or patent applications which are revoked or refused, but which are currently pending in appeal.

The underlying assessment applied to arrive at the final rating should be based on a number of different factors such as probability factors. Typically, the model may rely on the results of search reports or examination reports available in the respective procedure. Accordingly, the citation of a number of highly relevant documents (X documents) against all claims will lead to a low survivability rating. The expected grant of a patent will lead to a higher rating. The grant of a patent will also lead to a higher rating than a patent application without search report. The underlying assessment might be changed and improved depending on the development of a patent system or field of technology. The details of the changes do not need to be communicated to all the bidders. The bidders only need to be aware of the meaning and reliability of the rating levels.

A suitable survivability assessment may be based on a theory wherein the following assumptions are made.

A patent application represents a semantic system. The semantic system comprises statements including the problem and the solution (description, optionally drawings) and the definition (claims) of the subject matter of the invention. In examination proceedings, the semantic system is subjected to a patentability operator. Under European jurisdiction, the patentability operator is derived from the European patent convention (EPC) providing rules and articles defining, all properties of the patentability operator for deciding on the survivability of a patent application or patent A complete operator for the examination of patentability during substantive examination is highly complex as it involves as terms the following provisions of the EPC, usually in the following order:

Rule 27, Article 84, Article 83, Article 82, Rule 30, Article 76, Article 52(2), Article 53a),b), Articles 52(4), 57, Article 54, Article 56, Article 123(2), and after grant also

### Article 123(3).

The operator may of course be extended to provisions which are relevant for the examination in earlier stages of the examination.

Different terms of the patentability operator (different provisions) are applied to different portions (claims, application as a whole) of the semantic system. Moreover, the application of a specific term of the patentability operator may be limited to the semantic system as such, or a specific term of the patentability operator may require further evidence in the form of semantic systems from the prior art, the relevant non-prepublished references and the general knowledge in the art. As a result of the application of the patentability operator on the semantic system of the patent application or patent, a decision on the grant of a patent (Article 97(1)), the rejection of an opposition (Article 101(2)), or the maintenance of the patent (Article 101 (3)) is taken in favor of a survivability, or alternatively, a decision on the refusal of the application (Article 97(2)) or the revocation of the patent (Article 101(2); 101 (3a)) may be taken. Prior to a final decision, the applicant or patent proprietor is given the opportunity to make amendments to the semantic system, whereby the patentability operator is applied again.

The application of the patentability operator on the semantic system is carried out by a competent examiner acting for and being controlled by an Examining Division. Given that the application of the patentability operator is highly complex due to the large number of terms and the complexity of the semantic system, the competent examiner makes choices in the course of the application of the patentability operator. The choices made by the competent examiner and the results of the application of the patentability operator on the pending semantic system are reflected by examination reports. Specifically, the competent examiner simplifies the complete patentability operator by disregarding certain terms which are not considered to be of relevance for a survivability. Moreover, the competent examiner will provide his assessment of the application of the simplified patentability operator in the form of a set of statements. The choices made by the examiner in simplifying the patentability operator and the statements included in an examination report contain information on the survivability of the semantic system of the patent application without the necessity of studying the semantic system in detail. Accordingly, the survivability rating may be based on the choices regarding the patentability operator and statements made by the examiner with regard to the currently pending semantic system of the patent application. In the absence of an examination report, the results of the search report may be used as a reduced basis for the survivability rating without an in depth examination of the semantic system. Prior to the search report, it must be assumed that the semantic system as such was not yet examined by a competent examiner. Since large differences in terms of the quality of the semantic systems exist, the survivability rating has to rely on the general probability for success of and invention in the specific field of technology, which may as such be already a good starting point. Once a patent has been granted, it may be assumed that the original semantic system has been standardized during examination proceedings so that the general probability for an opposition and the general probability success of an invention in the specific field of technology provides meaningful results.

Accordingly, a theory may be used wherein a published European patent application obtains a rating of 2 stars prior to the preparation of the search report. This rating may be adjusted based on the general probability of patent application in the respective class. Based on the results of the search report, the rating may be increased or decreased. Based on the results of the first office action, the rating is again reassessed. If the examiner intends to grant a patent on the pending semantic system, then the rating may be increased to a four star rating. If the simplified patentability operator applied by the examiner and the statements of the examiner are extremely negative, then the rating is adjusted to a one star rating. The reassessment is repeated for any official action issued in the proceedings. Once the Examiner intends to grant a patent, the rating is increased to four stars. In case the Examiner refuses the application, the rating is decreased to a single star. If a loss of rights occurs due to a non-payment of a fee, the rating may be suspended and no star is given. If a patent is granted and no opposition is filed, then the rating is increased to a five star rating indicating the highest survivability. If an opposition is filed, then the rating is adjusted based on probabilities and the results of the examination during opposition proceedings by the European patent office.

A suitable rating theory may furthermore be based on determinants and indicators identified for the evaluation of patents according to the following published references: Hall, B. H. and D. Harhoff (2004). “Post Grant Review Systems at the U.S. Patent Office—Design Parameters and Expected Impact,” Berkeley Law Technology Journal; Harhoff, D. and M. Reitzig (2004). “Determinants of Opposition against EPO Patent Grants—The Case of Biotechnology and Pharmaceuticals,” International Journal of Industrial Organization, 22 (4), 443-480; Harhoff, D., F. M. Scherer and K. Vopel (2003). “Citations, Family Size, Opposition and the Value of Patent Rights—Evidence from Germany,” Research Policy, 32, 1343-1363; Harhoff, D., F. Narin, F. M. Scherer and K. Vopel (1999). “Citation Frequency and the Value of Patented Innovation,” Review of Economics and Statistics, 81 (3), 511-515; Harhoff, D. and K. Hoisl (2004). “European Patent Citations—How to count and how to interpret them,” University of Munich.

The survivability rating is independent from the interests of the patent proprietors or applicants or representative thereof. The survivability rating is independent from the interests of the bidders. The survivability rating is also independent from the interests of the means for conducting an online auction. The independence of the survivability rating is crucial for the function of the marketplace in ideas. Preferably, the method underlying the survivability rating is published in order to enhance transparency of the rating system.

The independent survivability rating of the patents and patent applications allows the public to identify quickly and reliably patents and applications, which are abandoned for reasons of lack of patentability or deficient disclosures. It must be expected that patent proprietors or applicants will attempt to capitalize on deficient disclosures or non-patentable subject matter by taking advantage of inexperienced bidders. Potential bidders will be in a difficult position to identify the inherent problems of a patent or patent application without great efforts. Accordingly, an independent survivability rating of the patents and patent applications will protect the public and simplify the identification of a valuable patent or patent application. Accordingly, it will be possible for less experienced bidders to take part in an online auction while reducing the risk for a total loss on the invested capital. Accordingly, it will be possible for new circles of the public outside the specific field of technology of the respective patent or patent application to be actively involved in the transfer of patents or patent applications for investment purposes. Accordingly, it may be possible for the investment community to invest in patents and patent applications in emerging fields of technology by bidding for patents or patent applications having a high survivability rating from start-up companies in financial difficulties. Members of the investment community might be able to build a portfolio of relevant intellectual property assets which may prove to be highly valuable in the future.

The independent rating of the patents and patent applications indicates a probability by which the value might become zero in the future. The survivability rating does not indicate a specific value of a patent or application, which depends on the interest of the third party considering to place an offer. The interest of an anonymous third party may be in acquiring an intellectual property asset as an addition to an existing portfolio covering an existing product. The interest of the anonymous third party may be in acquiring an intellectual property asset in order to build a portfolio whereby the motivation for the existing portfolio may be based on an existing or future product or the future licensing of the portfolio. Finally, the interest of the third party considering to place an offer may be more speculative in nature, whereby the portfolio is ultimately offered in the online auction. The question of freedom to operate is of different relevance for different third parties, and will not be considered in the patent rating. Accordingly, the proprietor of a dominating patent or a speculative investor has no concern regarding the question of freedom to operate. On the other hand, the question of freedom to operate is of high relevance for a third party interested in the development of a new product. Therefore, aspects of the freedom to operate determine the interest of a third party and therefore the offer it is ready to make. However, aspects of the freedom to operate do not determine the actual value of the patent or application in case parties are involved for which the freedom to operate a specific product is of no concern. Therefore, the question of the freedom to operate is assigned to the part of the bidders having products, which are usually aware of third party patents.

In a preferred embodiment, the means for conducting an online auction of patents and patent applications may allow the placement of a request for an opinion on a due diligence issue regarding the patent Accordingly, a third party may communicate to the means for providing a rating of the patents and patent applications subject to the online auction a standardized request for a subjective evaluation or regarding a specific question. The request may then be transmitted to the requesting party directly, or added to the listing of the patent or application in the auction. In order to increase the potential value of the patent or application subject to the auction, the patent proprietor or applicant may also place a request by communicating with the means for providing a survivability rating. A rating system for a subjective rating may be as follows.

### Rating “AAA”

Patent assets which are rated AAA are judged to be of the best quality with regard to the risk that the value would become zero in the future. They carry the smallest degree of investment risk. Revocation or nullification of the claims is highly unlikely due to the nature of the invention and the results of previous examination, opposition or opposition appeal proceedings.

### Rating “AA”

Patent assets which are rated AA are judged to be of high quality by all standards with regard to the risk that the value would become zero in the future. Together with the AAA group they comprise high grade patent assets. They are rated lower than the best patent assets because margins of protection may not be as large as in AAA patent assets or there may be other elements present which make the long-term risk appear somewhat larger than the AAA rated assets.

### Rating “A”

Patent assets which are rated A possess many favourable aspects which may reduce the risk that the value would become zero in the future and are considered as upper-medium-grade assets. Factors giving security to patentability are considered adequate, but elements may be present which suggest a susceptibility to impairment some time in the future, such as a development in the patent practice.

### Rating “BBB”

Patent assets which are rated BBB are considered as medium-grade assets. The prior art risk appears adequate for the present claims, but certain protective elements may be lacking or may be characteristically unreliable over any great length of time. Such patent assets lack outstanding investment characteristics and in fact have speculative characteristics as well.

### Rating “BB”

Patent assets which are rated BB are judged to have speculative elements; their future cannot be considered as well-assured. Often the protection provided may be very moderate, and uncertainty of protection characterizes patent assets in this class.

### Rating “B”

Patent assets which are rated B generally lack characteristics of a desirable investment. Assurance of the protection over any long period of time may be small.

### Rating “CCC”

Patent assets which are rated CCC are of poor standing. There may be present a large number of highly relevant references representing a danger with respect to the patentability of the claimed subject matter in the future.

### Rating “CC”

Patent assets which are rated CC represent assets which are speculative in a high degree.

### Rating “C”

Patent assets which are rated C are the lowest rated class of patent assets, and patents or applications so rated can be regarded as having extremely poor prospects of ever attaining any real investment standing.

Any bidder may choose to rely on a mechanism to maintain confidentiality of his identity and his bid information in perpetuity. The means for conducting an online auction of patents and patent applications may maintain the bidder's registration information separate from the bid itself in a confidential bidder's database by assigning an arbitrary bid number to the bid. The means for conducting an online auction of patents and patent applications may maintain a relationship between the bid number and the unique registration number of the bidder in the bidder's database. The seller does not have access to the bidder's registration database. The means for conducting an online auction of patents and patent applications secures the unique registration number of the bidder from the patent proprietor or applicant. The means for conducting an online auction of patents and patent applications may index the bid number based upon the unique registration number in a manner that the patent proprietor or applicant can only access the bid number. Once the winning bid is determined upon termination of the auction, the means for conducting an online auction of patents and patent applications contacts the bidder corresponding to the unique registration number assigned to the bid number and notifies the winning party about the winning bid. Preferably, all other bids for the auction are eventually deleted.

The winning bidder may be requested to pay the respective bidding amount in an escrow account. As soon as the bidding amount is received in the escrow account, the means for representing a patent or patent application subject to the auction will manage the transfer of the asset, which includes an assignment of the asset and a registration of the assignment in the relevant patent offices. As soon as the patent proprietor or applicant has fulfilled its duties in the transfer, the bidding amount will be transferred to the patent proprietor or applicant. Any fees and costs involved in the transaction may be deducted.

The present invention reverses the conventional market mechanism. In the conventional marketplace in ideas, the patent proprietor or applicant might be able to identify a third party acquiring an intellectual property asset as an addition to an existing portfolio covering an existing product. However, any other potentially interested third party cannot be identified by the patent proprietor or applicant. The competition of the interests of all bidders will be a chance for the patent proprietor or applicant to establish the optimum value of his auctioned patent or patent application.

The combination of a standardized (objective) rating of the survivability of a patent or patent application and the online auction of a patent or application allows the public to easily identify patents or applications which are abandoned due to the lack of a contribution to the state of the art of the claimed subject matter. Such patents or applications may still represent a value in case unclaimed subject matter is contained in the application which could be pursued in the future. However, in order to facilitate the identification of potentially relevant patents or patent applications, the listing of the patents or patent applications should be combined with further features such as keywords, classifications such as the IPC or specific names of applicants/proprietors or inventor. Accordingly, the public may monitor the means for conducting an online auction of patents and patent applications with regard to specific criteria such as a minimum survivability rating and a specific IPC class.

In a preferred embodiment the means for conducting an online auction comprise as a database containing information regarding patents and patent applications, and optionally further patent assets which were sold in the past. The information may comprise the final sales price, the number of bids, the date of the sale, the number of separate patent assets involved in the transaction, and any other information contained in and the official patent register, such as the IPC classifications, the filing date, and the name of the applicant and/or inventor. The database may be accessed by the public in order to obtain information with regard to the value of patent assets. Such information may be used in unrelated transactions, such as corporate transactions or license agreements. Based on the information contained in this database, market transparency in the field of patent assets may be increased.

### BRIEF DESCRIPTION OF THE DRAWINGS

The present invention will now be described in conjunction with the attached drawings in which:

FIG. 1 is a block diagram illustrating the European market in ideas and system;

FIG. 2 is a block diagram illustrating the procedure for placement of an asset in the means for conducting an online auction.

FIG. 3 is a block diagram illustrating the procedure for obtaining a survivability rating from the means for providing a survivability rating of a patent or patent application and publishing the listing in the online auction.

FIG. 4 is a block diagram illustrating the procedure for placement of a bid in the means for conducting an online auction.

FIG. 5 is a block diagram illustrating the procedure after the auction is terminated.

FIG. 6 is a schematic representation of a general purpose computer system capable to be programmed to perform the special purpose functions of one or more of the elements shown in FIG. 1.

### DESCRIPTION OF THE PREFERRED EMBODIMENTS

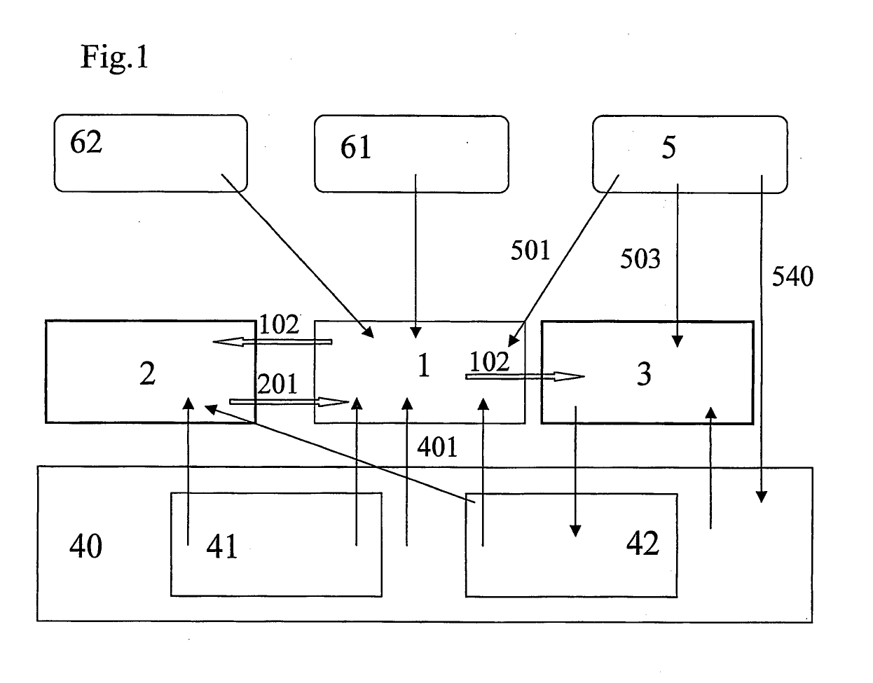

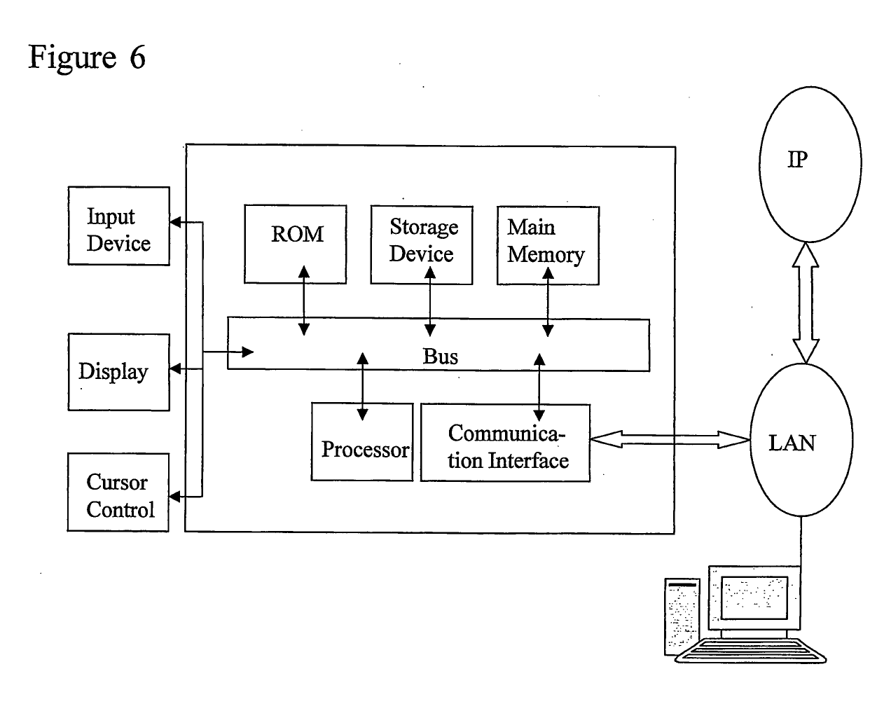

FIG. 1 is a schematic representation of a system of elements for a European market place in ideas. The system comprises a means 1 for conducting an online auction of patents and patent applications. The means 1 may be implemented on a computer connected to a network such as the Internet A general purpose computer is shown schematically in FIG. 6. The means 1 can be a Web server programmed to receive, retrieve, store, and transmit different types of information including bid information. Means 1 accepts a seller's or bidder's registration information for the purpose of identifying a seller or bidder with a seller's offers and bidder's bids in the auction of patent and patent applications. Preferably, means 1 maintains a seller's database and a bidder's database each containing data relating to the seller's registration and the bidder's registration, respectively. The bidder's database is preferably, not accessible for the public. Means 1 may create a unique index number to index the bids and the bidder information in means 1. Means 1 is communicatively interconnected via the communication system to the bidder's computer. The bidder's computer may be any computer that a bidder may access, such as home or office computer or any other device fulfilling the required function such as a mobile telephone. The bidder's computer may be programmed to work with any suitable web browser software to retrieve the Web pages of means 1 via a communications system operating on the Internet from a remote server such as the means 1. The bidder may use the Web browser on its computer to transmit registration and bid information to the means 1. Means 1 is also communicatively interconnected via the communication system to the bidder's computer. The seller's computer may also be programmed to work with any suitable web browser software to retrieve Web pages via a communications system operating on the Internet from a remote server such as the means 1. The seller may use the Web browser on its computer to transmit registration and offer information to the means 1.

The system further comprises a means 2 for providing an independent survivability rating of a patents or patent application subject to the online auction which is based on a standardized assessment evaluating the survivability of the patent application or patent in the future. The means 2 has access to the official register 41 and file 42 maintained in the patent office 40. Accordingly, the completeness and accuracy of the data on which the survivability rating is based is beyond doubt.

Means 1 maintains a seller's database, e.g. of patent proprietors and patent applicants involved in the online patent auction or administrators of the bankrupt estate thereof. The database contains information on the legal entities of the of patent proprietors and patent applicants or administrators of a bankrupt estate. The database further contains banking information of the patent proprietors and patent applicants. Moreover, the database further contains evidence that the patent proprietors and patent applicants agree to the internal rules of conducting online auctions of patents and patent applications as set by means 1.

Means 1 may receive a registration of a seller, the identification of an intellectual property asset and a request for including a specific patent or patent application into the online auction of patents and patent applications. In a preferred embodiment, the request also contains an indication that representation is to be transferred to a means 3 for representing a patent or patent application subject to the auction before the European or national patent offices.

Besides the registration information of the seller, the request may simply contain an indication of an application number or publication number and an indication that the patent be included in the patent auction. The request may also contain a starting price and/or a reservation set by the seller. Moreover, the request may include evidence regarding the specific patent or patent application intended to inform the bidders on relevant facts and arguments increasing or decreasing the bidding amount. The request may also limit the assets of a specific patent or application. In one alternative, only the patent rights in specific countries may be offered. In a further alternative only a specific set of claims supported by the disclosure might be offered. It may also be possible to offer a license to a specific patent or patent application. Moreover, in a further alternative a set of patents or patent applications might be offered as a package. Specifically, the means for conducting an online auction may list the assets of the package based on the European patent applications and patents separately as well as the package. Accordingly, it is possible for bidders to place bids for the single European patent applications and patents and/or the entire package. Preferably, the bids for the package have priority so that any bid for the entire package will at the same time prevail over bids for single European patent applications and patents contained in the package. It might furthermore be contemplated to offer an option to a license in the future or an option on the revenues generated with a license on a specific patent or patent application.

The request may further indicate a time when the patent auction will end. By default, the auction may end before the patent or patent application lapses e.g. for non-payment of fees within a term.

The request 501 may be received by means 1 directly from the patent proprietor or applicant 5. Alternatively, the request 401 may be received from the patent office 40 upon request 540 of the patent proprietor or applicant 5. Means 1 or the patent office maintain a means for verifying the admissibility of the request for including a specific patent or patent application into the online auction of patents and patent applications. The admissibility may be checked based on the entitlement of the requesting party and the status of the subject patent. If the requesting party is not entitled to submit the request or if the patent or application is not an asset anymore, then the request is refused. The requesting party may be informed accordingly. Provided that the request is considered admissible, the natural persons or legal entities entered in the patent office are informed accordingly. Specifically, the registered applicant or proprietor are informed about the inclusion of the patent or application. Moreover, the inventors and licensees may also be informed in order to protect any legitimate interests of all parties concerned.

In a preferred embodiment, representation is transferred to a means 3 for representing a patent or patent application subject to the auction before the European or national patent offices. Accordingly, the patent proprietor or applicant who otherwise would abandon the patent or application will not be burdened with efforts and the risk of costs in maintaining the patent or application and in managing the transfer to any third party. Moreover, means 3 monitors the relevant terms for maintaining the patent or application during the online auction and takes any necessary action for continuing the proceedings. Accordingly, means 3 receives an order 103 from means 1, preferably over a network such as the Internet, to take over representation as soon as the request for including a specific patent or patent application into the online auction of patents and patent applications is considered admissible.

Means 2 receives a request 102 from means 1, preferably over a network such as the Internet, for a survivability rating as soon as the request for including a patent or patent application in the online patent auction is considered admissible. Preferably, the request includes a term by which the survivability rating is to prepared. Means 2 maintains a standardized assessment for conducting a survivability rating. The model is based on parameters retrievable from the official patent register 41 and file 42 maintained in the patent office 40. Means 2 may maintain more than one standardized model for conducting a survivability rating. Accordingly, it is possible, that different assessment models are used for granted patents and patent applications. The rating may change depending on the state of the official file. Accordingly, means 2 may check the official file periodically and update the rating accordingly.

The standardized assessment evaluates the survivability of the patent or application as an intellectual property asset in the future. The assessment represents a current opinion on the likelihood that the patent or application will be limited or disappear as an intellectual property asset due to patentability issues of the claimed subject matter. The survivability assessment is based on current information available from public databases such as from the official register 41 and file 42.

The rating may use a system wherein a patent or patent application is assigned a number of stars depending on the likelihood that the patent or application will be limited or disappear as an intellectual property asset due to patentability issues of the claimed subject matter. Accordingly, the specific patent or patent application is assigned to a single rating level of the following objective survivability rating system:

5 stars indicate an extremely strong likelihood for the patent or application to survive
4 stars indicate a strong likelihood for the patent or application to survive
3 stars indicate adequate likelihood for the patent or application to survive
2 stars indicate uncertainties regarding likelihood for the patent or application to survive
1 star indicates a currently vulnerable patent or application
0 stars indicate patents or patent applications which are revoked or refused, but which are currently pending in appeal.

The independent rating of the patents and patent applications indicates a probability by which the value might become zero in the future. The survivability rating does not indicate a specific value of a patent or application, which depends on the interest of the third party considering to place an offer. The independent survivability rating of the patents and patent applications allows the public to identify quickly and reliably patents and applications, which are abandoned for reasons of lack of patentability. For certain purposes, even a patent or patent application with a low rating may represent a value for a bidder. In one alternative, a patent application might contain a disclosure of an unclaimed embodiment which might be successfully pursued in a divisional application by a third party. In another alternative, an opponent might choose to bid for an opposed patent which was revoked and entered into the online patent auction by the proprietor.

The rating is transmitted by a message 201 from means 2 to means 1, preferably over a network such as the Internet.

The means 1 assigns the survivability rating from message 201 to the specific patent or patent application and publishes the listing online together with any further information relevant for the listing of the patent or patent application. Accordingly, a listing may contain the indication of the official application or publication number, an independent survivability rating, the IPC class of the claimed subject matter, a title, the current patent proprietor or applicant or a link to the respective homepages, the starting price, and the end of the online auction. Moreover, the listing may contain links to the official register of the patent office and the Online File Inspection for the relevant patent or patent application. Finally, the listing may contain an estimate of the costs for maintaining the patent asset in the future such as a annuity fees or other official fees, possible translation costs and professional fees. Means 1 provides all listings in a searchable form so that third parties 61, 62 may easily identify patents and patent applications relevant for a specific field.

Means 1 maintains a database of bidders. The database contains information on the legal entities of bidders. The database further contains banking information of the bidders. Moreover, the database further contains evidence that the bidders agree to the internal rules of conducting online auctions of patents and patent applications as set by means 1.

Bidders may choose to submit a bid anonymously. Accordingly, it is not necessary for the bidder to disclose its interest in a certain subject matter in case his bid in the auction is unsuccessful. If the bidder chooses to bid anonymously, then the means 1 only discloses a bid number assigned to a specific bid, whereby the identity of the bidder is not disclosed.

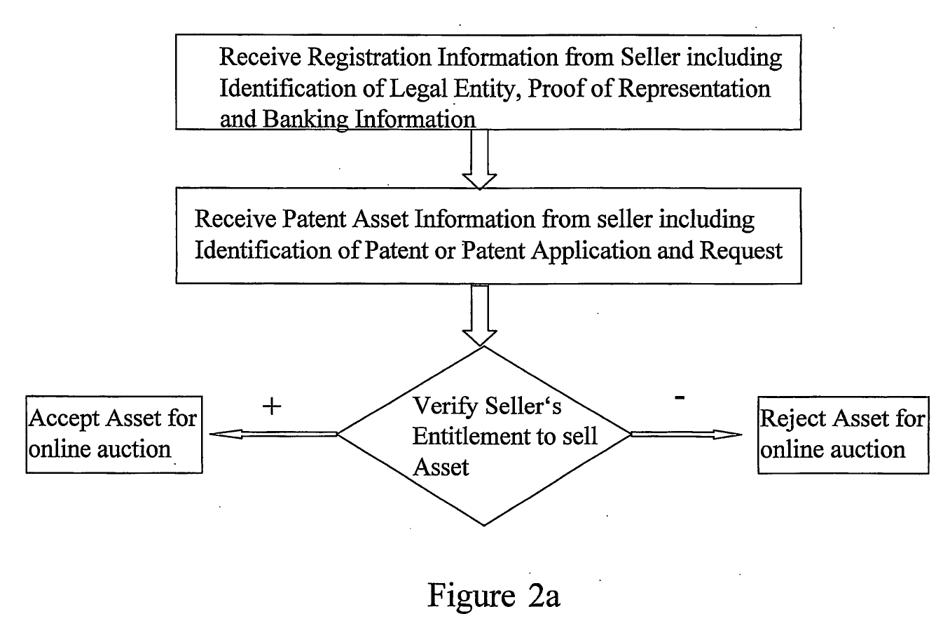

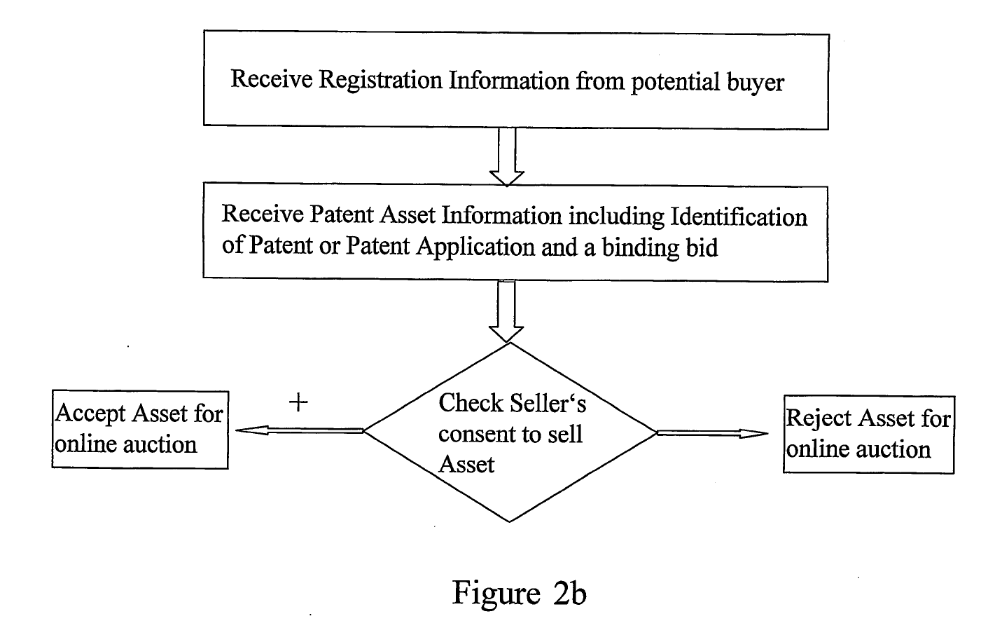

FIG. 2a illustrates schematically the registration of a seller and the respective intellectual property asset identified by the seller to the means 1 and the verification of the entitlement of the seller. Accordingly, means 1 receives registration information from seller including identification of natural person or legal entity, proof of representation and banking information. Patent asset information is then received from seller including identification of patent or patent application and a request to include the patent asset into the online auction. The seller's entitlement to offer, sell and assign the asset is then verified. In case the verification fails, the request is refused and the patent asset is not included in the online patent auction. In case the verification is successful, the patent asset is accepted for the online auction.

FIG. 2b illustrates schematically the registration of a potential buyer and the respective intellectual property asset identified by the potential buyer to the means 1 together with a binding bid. Accordingly, means 1 receives registration information from a potential buyer including identification of natural person or legal entity, proof of representation and banking information. Patent asset information is then received from potential buyer including identification of patent or patent application and a request directed to the proprietor or applicant to include the patent asset into the online auction. The proprietor or applicant is then contacted for his consent to the sale of his patent asset. In case the proprietor or applicant does not consent, the request of the potential buyer is refused and the patent asset is not included in the online patent auction. In case consent is obtained from the proprietor or applicant, the patent asset is accepted for the online auction.

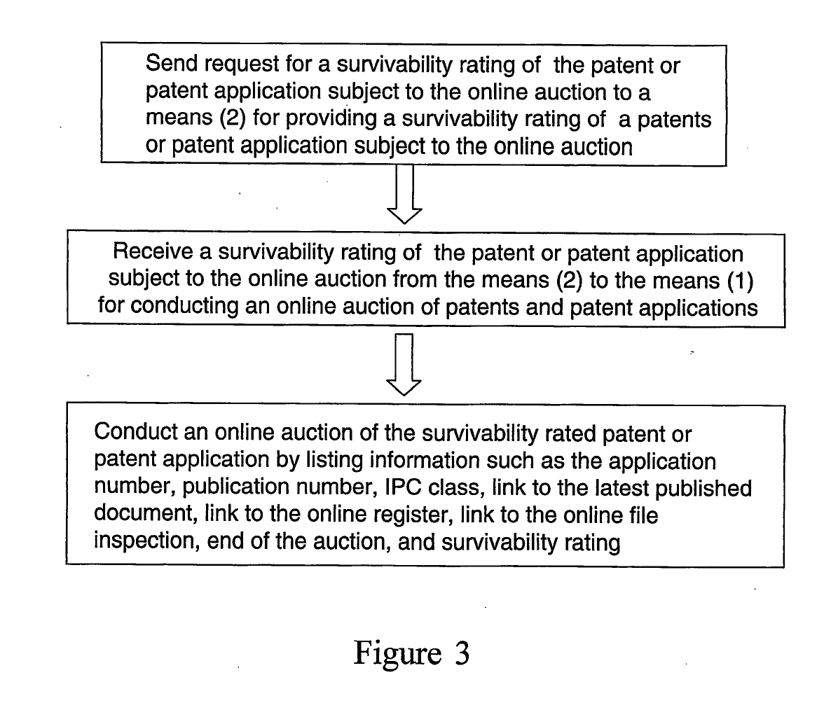

FIG. 3 illustrates the request for a survivability rating from means 1 to means 2 after the intellectual property asset has been verified for the online auction of patents and patent applications. Accordingly, a request for a survivability rating of the patent or patent application subject to the online auction is sent to a means 2 for providing a survivability rating of a patents or patent application subject to the online auction. Subsequently, a survivability rating of the patent or patent application subject to the online auction is received from the means 2 by the means 1 for conducting an online auction of patents and patent applications. Subsequently, an online auction of the survivability rated patent or patent application is conducted by listing information such as the application number, publication number, IPC class, link to the latest published document, link to the online register, link to the online file inspection, end of the auction, estimated maintenance costs and survivability rating.

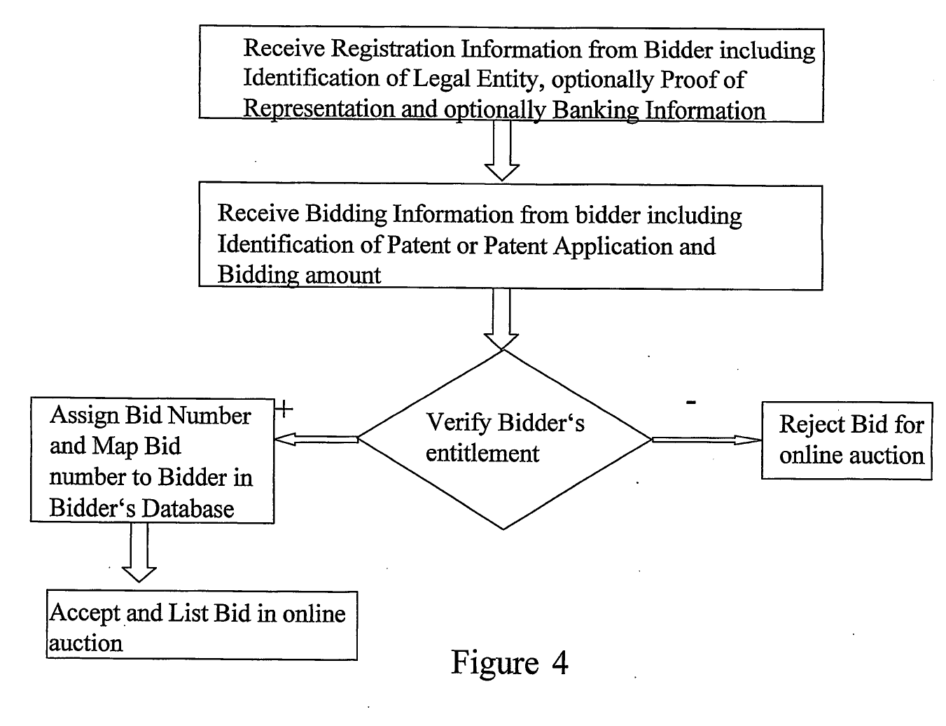

FIG. 4 is a block diagram illustrating the procedure for placement of a bid in the means for conducting an online auction. Accordingly, registration information is received by means 1 from bidder including identification of natural person or legal entity, optionally proof of representation and optionally banking Information. Moreover, bidding information is received from bidder including identification of patent or patent application and bidding amount. In a preferred embodiment, the bidder's entitlement is verified. The bid may be refused if the bidder's entitlement cannot be verified. In a preferred embodiment, a bid number is assigned and the bid number is mapped to a bidder in bidder's database. Subsequently, the bid is accepted and listed in the online auction.

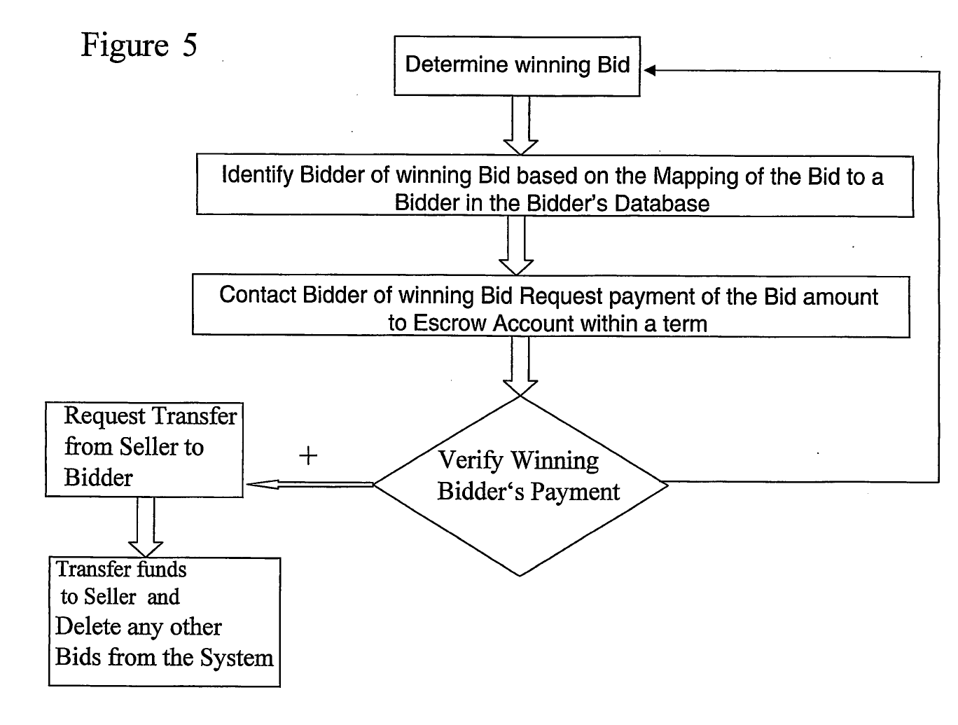

FIG. 5 is a block diagram illustrating the procedure after the auction is terminated. Accordingly, the winning bid is determined. Moreover, the bidder is identified based on the mapping of the bid number to the bidder in the bidder's database, if necessary. Subsequently, the bidder is contacted and requested to pay the bidding amount into an escrow account preferably within a term. Alternatively, the buyer may be requested to pay directly to the seller's account. If the bidding amount is not received within a term, then a new winning bid may be determined. If the bidding amount is received within the term, then the assignment of the patent asset is carried out and the assignment is registered in the official patent registers. Finally, the bidding amount is transferred to the seller's account, if necessary, and preferably any other bid information is deleted from the computer system memory.

FIG. 6 illustrates a computer system upon which an embodiment of a means 1 according to the present invention may be implemented. Computer system includes a bus or other communication mechanism for communicating information, and a processor coupled with bus for processing the information. Computer system also includes a main memory, such as a random access memory (RAM) or other dynamic storage device, coupled to bus for storing information and instructions to be executed by processor. In addition, main memory may be used for storing temporary variables or other intermediate information during execution of instructions to be executed by processor. Computer system further includes a read only memory (ROM) or other static storage device coupled to bus for storing static information and instructions for processor. A storage device, such as a magnetic disk or optical disk, is provided and coupled to bus for storing information and instructions.

Computer system may be coupled via bus to a display, such as a cathode ray tube (CRT), for displaying information to a computer user. An input device, including alphanumeric and other keys, is coupled to bus for communicating information and command selections to processor. Another type of user input device is cursor control, such as a mouse, a trackball, or cursor direction keys for communicating direction information and command selections to processor and for controlling cursor movement on display.

According to one embodiment, mapping a set of object life cycle states to one or more sets of business rules is provided by computer system in response to processor executing one or more sequences of one or more instructions contained in main memory. Such instructions may be read into main memory from another computer-readable medium, such as storage device. Execution of the sequences of instructions contained in main memory causes processor to perform the process steps described herein. One or more processors in a multi-processing arrangement may also be employed to execute the sequences of instructions contained in main memory. In alternative embodiments, hard-wired circuitry may be used in place of or in combination with software instructions. Thus, embodiments are not limited to any specific combination of hardware circuitry and software.

Further, the mapping of notifications to business rule triggers may reside on a computer-readable medium. The term a “computer-readable medium” as used herein refers to any medium or media that participate in providing instructions to processor for execution. Such a medium may take many forms, including but not limited to, non-volatile media, volatile media, and transmission media. Non-volatile media includes, for example, optical or magnetic disks, such as storage device. Volatile media includes dynamic memory, such as main memory. Transmission media includes coaxial cables, copper wire and fiber optics, including the wires that comprise bus. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor for execution. For example, the instructions may initially be carried on a magnetic disk of a remote computer. The remote computer can load the instructions relating to the notification services to control call processing remotely into its dynamic memory and send the instructions over a telephone line using a modem. A modem local to computer system can receive the data on the telephone line and use an infrared transmitter to convert the data to an infrared signal. An infrared detector coupled to bus can receive the data carried in the infrared signal and place the data on bus. Bus carries the data to main memory, from which processor retrieves and executes the instructions The instructions received by main memory may optionally be stored on storage device either before or after execution by processor.

Computer system also includes a communication interface coupled to bus. Communication interface provides a two-way data communication coupling to a network link that is connected to a local network. For example, communication interface may be a network interface card to attach to any packet switched local area network (LAN). As another example, communication interface may be an asymmetrical digital subscriber line (ADSL) card, an integrated services digital network (ISDN) card or a modem to provide a data communication connection to a corresponding type of telephone line. Wireless links may also be implemented. In any such implementation, communication interface sends and receives electrical, electromagnetic or optical signals that carry digital data streams representing various types of information.

Network link typically provides data communication through one or more networks to other data devices. For example, network link may provide a connection through local network to a host computer or to data equipment operated by a service provider, which provides data communication services through an IP (Internet Protocol) network (e.g., the Internet). LAN and IP network both use electrical, electromagnetic or optical signals that carry digital data streams. The signals through the various networks and the signals on network link and through communication interface, which carry the digital data to and from computer system, are exemplary forms of earner waves transporting the information. Computer system can transmit notifications and receive data, including program code, through the network(s), network link and communication interface.

1. A system for implementing a marketplace in ideas, which comprises
a means (1) for conducting an online auction of patents and patent applications;
a means (2) for providing a survivability rating of a patent or patent application subject to the online auction, which is based on a standardized method evaluating the probability by which the value of a patent or patent application might become zero in the future,
whereby the means (1) and the means (2) are communicating by sending a request for a survivability rating for a specific patent or patent application from means (1) to means (2) and by sending a survivability rating for a specific patent or patent application from means (2) to means (1).

2. The system according to claim 1, which further comprises
a means (3) for representing a patent or patent application subject to the auction before the European or national patent offices.

3. The system according to claim 1, wherein the patent or patent applications are standardized patent assets.

4. The system according to claim 3, wherein two or more standardized patent assets may be combined to a portfolio containing standardized patent assets of the same patent applicant or patent proprietor.

5. The system according to claim 1, wherein the online auction is initialed by a potential buyer.

6. A method for practicing a marketplace in ideas, which comprises the following steps:
providing a means (1) for conducting an online auction of patents and patent applications;
providing a means (2) for providing a survivability rating of a patents or patent application subject to the online auction, which is based on a standardized method evaluating the probability by which the value of a patent or patent application might become zero in the future,
receiving a request to include a patent or a patent application into the online auction of patents and patent applications;
sending a request for a survivability rating of the patent or patent application subject to the online auction from the means for conducting an online auction of patents and patent applications to the means (2) for providing a survivability rating of a patents or patent application subject to the online auction;
sending a survivability rating of the patent or patent application subject to the online auction from the means (2) to the means (1) and displaying the rating in the listing of the patent or patent application subject to the online auction; conducting an online auction of the survivability rated patent or patent application.

7. A means (1) for conducting an online auction of patents and patent applications, which is a computer system comprising:
at least one computer;
at least one computer network connected to said computer;
means for receiving electronic offer information regarding an intellectual property asset from a prospective seller over said at least one computer network;
means for electronically forwarding offer information to a means (2) for providing a survivability rating of a patent or patent application over said at least one computer network or another computer network;
means for receiving from the means (2) for providing a survivability rating of a patent or patent application an electronic message indicating an objective survivability rating;
means for entering a record of such offer information and survivability rating into a database electronically accessible to a plurality of potential bidders over said at least one computer network or another computer network;
means for maintaining said record of such rated offer information in said database accessible to said plurality of prospective bidders for a predetermined period of time;
means for allowing said plurality of potential bidders to submit bids over said at least one computer network on such survivability rated offer of an intellectual property asset;
means for allowing the seller to access information regarding said bids from said plurality of bidders over said at least one computer network; and
means for determining a winning bid and deleting any other bid information from the computer system memory.

8. A means for conducting an online auction of patents and patent applications, which is a computer system comprising:
at least one computer;
at least one computer network connected to said computer;
means for receiving over said at least one computer network from a potential buyer electronic request information including a definition of a patent asset and a binding bid, for including an intellectual property asset into an online auction;
means for forwarding request information to the owner of the intellectual property asset without disclosing the identity of the potential buyer, preferably over said at least one computer network or another computer network, together with a request for communicating a decision on the request;
means for electronically forwarding request information to a means for providing a survivability rating of a patent or patent application over said at least one computer network or another computer network in case the request was granted by the owner of the intellectual property asset;
means for receiving from the means for providing a survivability rating of a patent or patent application an electronic message indicating an objective survivability rating;
means for entering a record of such request information and survivability rating into a database electronically accessible to a plurality of potential bidders over said at least, one computer network or another computer network;
means for maintaining said record of such request in said database accessible to said plurality of potential bidders for a predetermined period of time;
means for allowing said plurality of potential bidders to submit bids over said at least one computer network on such survivability rated offer of an intellectual property asset;
means for allowing the seller to access information regarding said bids excluding the identity of the bidders, from said plurality of bidders over said at least one computer network; and
means for determining a winning bid, and preferably deleting any other bid information from the computer system memory.

9. A computer readable medium containing program instructions for execution on a computer system, which when executed by the computer system, cause the computer system to perform method steps for auctioning an intellectual property, said method comprising the steps of:
receiving a request to include a patent or a patent application into the online auction of patents and patent applications;
sending a request for a survivability rating of the patent or patent application subject, to the online auction to a means (2) for providing a survivability rating of a patents or patent application subject to the online auction;
receiving a survivability rating of the patent or patent application subject to the online auction from the means (2) to the means (1) for conducting an online auction of patents and patent applications;
conducting an online auction of the survivability rated patent or patent application.
